(19) United States
(12) Patent Application Publication
(10) Pub. No.: US 2019/0297842 A1
(43) Pub. Date: Oct. 3, 2019

(54) Pet Water Fountain

(71) Applicant: Junzhou Huang, Shenzhen (CN)

(72) Inventor: Junzhou Huang, Shenzhen (CN)

(21) Appl. No.: 15/981,886

(22) Filed: May 16, 2018

(30) Foreign Application Priority Data
Mar. 30, 2018 (CN) 201820481981.X

(51) Int. Cl. A01K 7/02

(52) U.S. Cl. CPC A01K 7/02; B01D 35/30

(57) ABSTRACT

A pet water fountain is disclosed, comprising a basin configured to hold water, a pump detachably mounted at the bottom of the basin, a filter and a cover. The filter has a filter inlet and a filter outlet, the filter inlet being provided at the bottom of the filter and being detachably connected to a pump outlet of the pump, the filter outlet being provided at the top of the filter. The cover is placed in the basin and covering the pump and the filter, wherein a cover outlet is formed at the top of the cover, being connected to the filter outlet, and at least one circulating opening is configured at the bottom of the cover to connect inside and outside of the cover.

### CROSS REFERENCE TO RELATED APPLICATIONS

The present application claims the benefit of Chinese Patent Application No. 201820481981.X filed on Mar. 30, 2018. All the above are hereby incorporated by reference.

### FIELD

The present application generally relates to pet feeding necessities, more particularly to pet water fountains.

### BACKGROUND

With development of economic level and improvement of living quality, more and more people have pets. Traditional and also the simplest device for feeding water to the pets is an open bowl or an open pot which is filled with water for the pets drinking. However, since pets such as cats and dogs like to drink flowing water, these feeding devices don't conform to such habit of the pets due to water filled in these feeding devices being stagnant water. Furthermore, water filled in these feeding devices are exposed to the air, then water will become stale after a certain time. Pets can't drink flowing and fresh water with these feeding devices, thereby healthy of pets will be affected.

### SUMMARY

The present application provides a pet water fountain capable of providing flowing and fresh water for pets drinking.

According to one aspect, a pet water fountain comprises a basin, a pump, a filter and a cover. The basin is configured to hold water. The pump is detachably mounted at the bottom of the basin. The filter has a filter inlet and a filter outlet, the filter inlet being provided at the bottom of the filter and being detachably connected to a pump outlet of the pump, the filter outlet being provided at the top of the filter. The cover is placed in the basin and covering the pump and the filter, wherein a cover outlet is formed at the top of the cover, being connected to the filter outlet, and at least one circulating opening is configured at the bottom of the cover to connect inside and outside of the cover.

In one embodiment, a recess is formed in the bottom of the basin, and the pump is attached in the recess by suction cups provided at the bottom of the pump.

In one embodiment, a filter sponge is arranged in front of a pump inlet of the pump.

In one embodiment, a wire guiding post is provided in an internal space of the basin that is covered by the cover, and the wire guiding post extends upwards from the bottom of the basin, having a wire guiding passage going from the top down to the outside of the bottom of the basin, and an electrical wire of the pump is led into the wire guiding passage from top to bottom and then is led out from the bottom of the basin.

In one embodiment, the top of the wire guiding passage is stuffed by a silicone plug, and the silicone plug has an edge that is capable of being bent back to covering the wire guiding post.

In one embodiment, a silicone tube is embedded into the cover outlet, and a lower end of the silicone tube is further embedded into the filter outlet.

In one embodiment, the filter comprises an upper housing, a lower housing, and a filtering core housed in an internal space surrounded by the upper housing and the lower housing that are interlocked with each other.

In one embodiment, the filtering core further comprises a frame, at least one non-woven filtering bags which is placed in the frame, an upper layer of non-woven cloth and a lower layer of non-woven cloth which are attached to corresponding upper end and lower end of the frame respectively.

In one embodiment, each of the non-woven filtering bags is filled with activated carbon and/or ion-exchange resin.

In one embodiment, a storage recess is formed at the top of the cover, with the cover outlet being at the bottom of the storage recess, and at least one spout is configured surrounding an upper edge of the storage recess at the top of the cover.

Objectives, features, and advantages of the present application will become apparent upon examining the following detailed description of an embodiment thereof, taken in conjunction with the attached drawings.

### BRIEF DESCRIPTION OF THE DRAWINGS

These and other features, aspects, and advantages of the present application will be better understood with regard to the following description, appended claims, and accompanying drawings as follows:

FIG. 1 is a perspective view of a pet water fountain according to an embodiment of the present application;

FIG. 2 is an exploded perspective view of the pet water fountain shown in FIG. 1;

FIG. 3 is a sectional view of the pet water fountain shown in FIG. 1;

FIG. 4 is an exploded perspective view of a filter according to an embodiment of the present application;

FIG. 5 is a perspective view of a pet water fountain according to another embodiment of the present application.

### DETAILED DESCRIPTION

To explain objects, technical solutions and advantages of the present application more clearly, the present application will be further described with reference to the accompanying drawings and embodiments in the following. It should be understood that, the specific embodiments described here are only for explanation, but not for limitation to the present application.

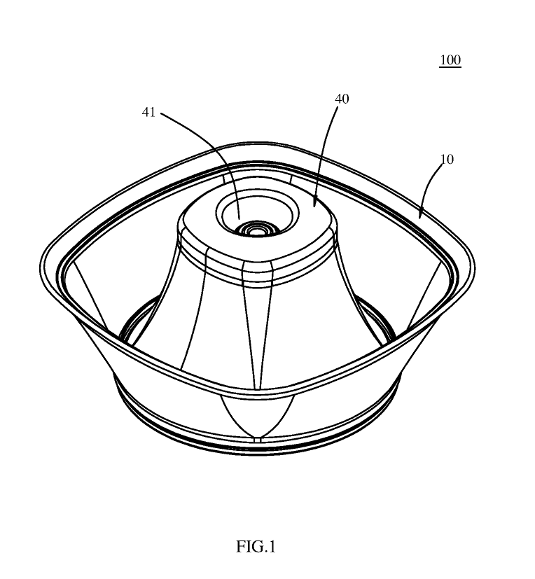

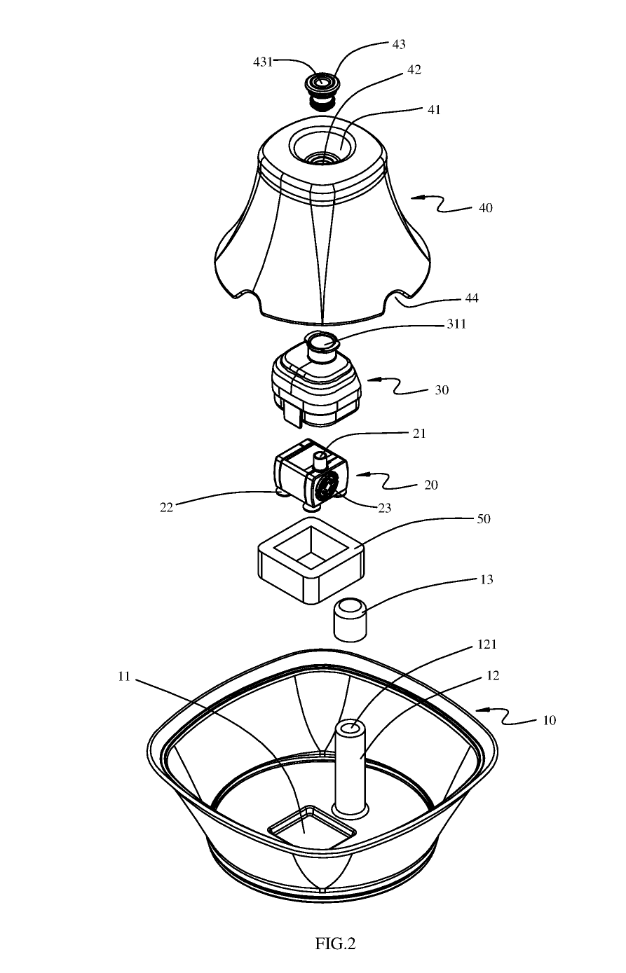

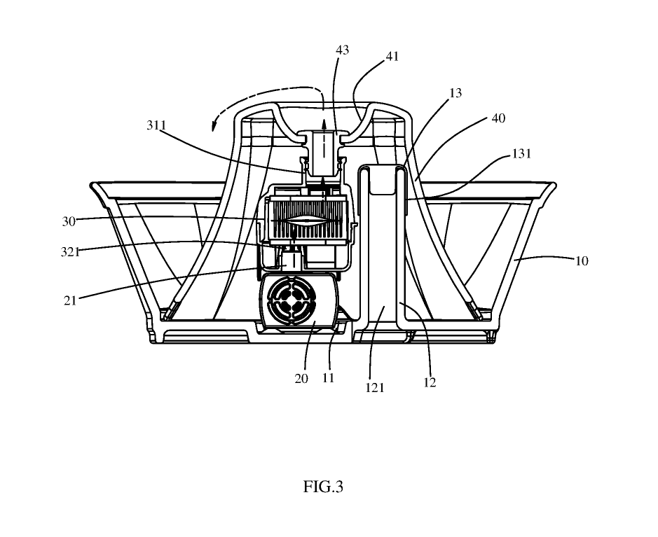

According to an embodiment as shown in FIG. 1 and FIG. 2, a pet water fountain 100 mainly comprises a basin 10, a pump 20, a filter 30 and a cover 40. The basin 10 is closed at the bottom, but opening at the top, used to hold water for pets drinking. A recess 11 is formed in the bottom of the basin 10, and the pump 20 is detachably mounted in the recess 11. For example, the pump 20 may be mounted in the recess 11 by suction cups 22 provided at the bottom of the pump 20, and a filter sponge 50 may be arranged in front of a pump inlet 23 of the pump 20. Preferably, a circle of filter sponge 50 is arranged surrounding the pump 20. The circle of filter sponge 50 is configured to pre-filter water flowing into the pump 20, to avoid matters such as pet hair entering into the pump 20, causing a breakdown of the pump 20. Further as shown in FIG. 2, a wire guiding post 12 is provided in an internal space of the basin 10 that is covered by the cover 40. The wire guiding post 12 extends upwards from the bottom of the basin 10, having a wire guiding passage 121 going from the top down to the outside of the bottom of the basin 10. An electrical wire of the pump 20 is led into the wire guiding passage 121 from top to bottom and then is led out from the bottom of the basin 10. Further, the top of the wire guiding passage 121 is stuffed by a silicone plug 13, and the silicone plug 13 has an edge 131 that is capable of being bent back to covering the wire guiding post 12 (referring to FIG. 3).

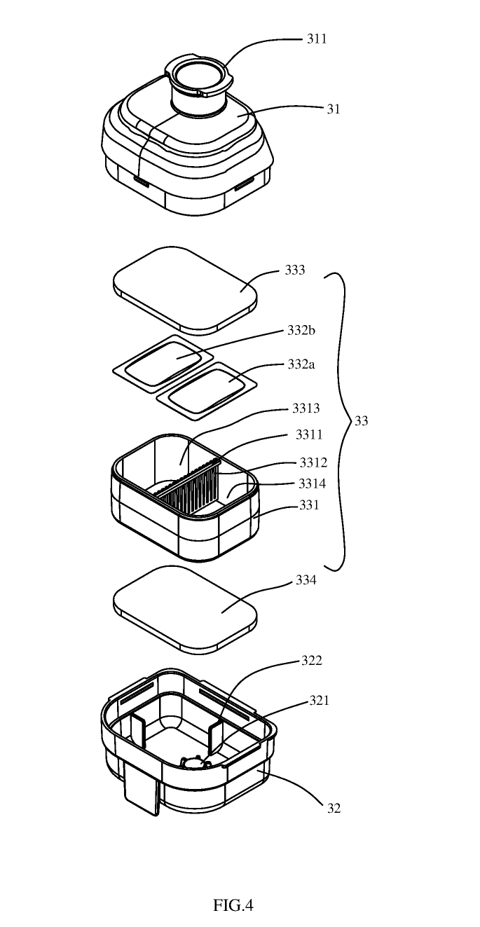

Further as shown in FIG. 2 and FIG. 3, the filter 30 has a filter inlet 321 and a filter outlet 311. The filter inlet 321 is provided at the bottom of the filter 30, being detachably connected to a pump outlet 21 of the pump 20. For example, the filter inlet 321 may be mounted on the pump outlet 21 by any suitable means such as interference fit or snap fit. The filter outlet 311 is provided at the top of the filter 30, being used to export water. Further referring to FIG. 4, the filter 30 comprises an upper housing 31, a lower housing 32, and a filtering core 33. The upper housing 31 and lower housing 32 are interlocked with each other. The filtering core 33 is housed in an internal space surrounded by the upper housing 31 and the lower housing 32, and is positioned by support ribs (e.g. a support rib 322) arranged in the upper housing 31 and the lower housing 32 respectively. The filter outlet 311 is provided at the top of the upper housing 31, and the filter inlet 321 is provided at the bottom of the lower housing 32. The pump outlet 21 is inserted into the filter inlet 321, thus water in the basin 10 is pumped into the filter 30 and filtered by the filtering core 33. The filtering core 33 further comprises a frame 331, two filtering bags 332a, 332b, an upper layer of non-woven cloth 333 and a lower layer of non-woven cloth 334. The frame 331 is separated into two cavities (i.e. a left cavity 3313 and a right cavity 3314) by a grid plate 3311, and a plurality of slots 3312 are formed on the grid plate 3311 for connecting the left cavity 3313 and the right cavity 3314. The two filtering bags 332a, 332b are placed in the left cavity 3313 and the right cavity 3314 respectively, and then the upper layer of non-woven cloth 333 and the lower layer of non-woven cloth 334 are attached to corresponding upper end and lower end of the frame 331 respectively, thereby the two filtering bags 332a, 332b are packaged in the filter. The two filtering bags 332a, 332b are formed by non-woven cloth with filtering materials such as activated carbon and/or ion-exchange resin being filled therein.

Further referring to FIG. 2 and FIG. 3, the cover 40 is horn shaped, and is directly placed in the basin 10 covering the pump 20, the filter 30 and the wire guiding post 12. A storage recess 41 is formed at the top of the cover 40, and a hole 42 is provided at the bottom of the storage recess 41, with a silicone tube 43 being embedded into the hole 42. A lower end of the silicone tube 43 is further embedded into the filter outlet 311, thus the filter outlet 311 is connected with the hole 42 of the storage recess 41 via the silicone tube 43. Water filtered by the filter 30 enters into the storage recess 41, and overflows from the top of the storage recess 41 after the storage recess 41 is full of water, and then returns back into the space between the basin 10 and the cover 40. A plurality of circulating openings 44 are configured at the bottom of the cover 40 to connect inside and outside of the cover 40. Through the circulating openings 44, water that overflows from the top of the storage recess 41 flows back into the internal space in the basin that is covered by the cover 40, then is pumped upwards again by the pump 10. Thus water circulation is realized.

As shown by the dotted lines with arrows in FIG. 3, water circulation process of the pet water fountain 100 is as below: water in the basin 10 is pumped by the pump 20 into the filter 30 via the pump outlet 21, then flows into the storage recess 41 on the top of the cover 40 via the filter outlet 311 and the silicone tube 43 after being filtered by the filter 30, and then overflows from the top of the storage recess 41 back into the basin 10 after the storage recess 41 is full. Then water flows through the filter sponge 50 and is pumped into the filter 30 again by the pump 20. Thus water circulation is realized, and water is cyclically filtered to keep fresh so as to protect health of the pets.

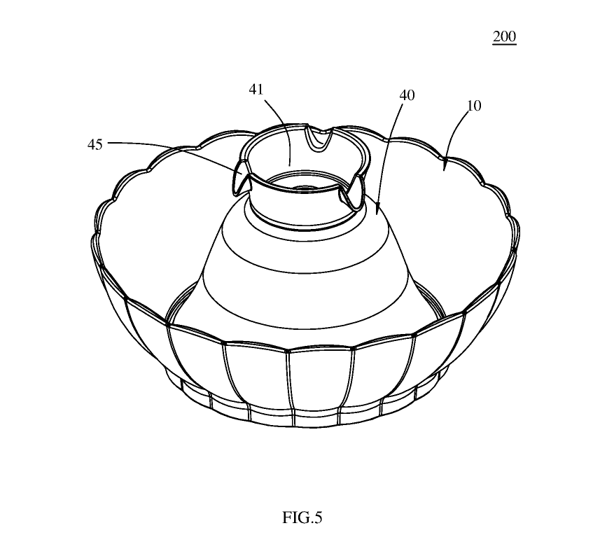

FIG. 5 shows a pet water fountain 200 according to another embodiment of the present application. The pet water fountain 200 has the same water circulation structure as the pet water fountain 100 as described above, and the only difference lies in that a plurality of spout 45 are configured surrounding an upper edge of the storage recess 41 at the top of the cover 40. Water in the storage recess 41 overflows from the spout 45, forming multiple strands of water flows falling down freely for pets drinking.

The pet water fountain according to the embodiments of the present application can provide flowing water to pets, and keep the flowing water clean and fresh, thus protect healthy of pets. Further, the cover of the pet water fountain is directly placed in the basin, bring a simple structure and is easy to maintain, especially being suitable for being made of ceramic.

Although the present application has been described with reference to specific embodiments thereof, these embodiments are merely illustrative, and not restrictive of, the present application. Various modifications or changes to the specifically disclosed exemplary embodiments will be suggested to persons skilled in the art. In summary, the scope of the application should not be restricted to the specific exemplary embodiments disclosed herein, and all modifications that are readily suggested to those of ordinary skill in the art should be included within the spirit and purview of this application and scope of the appended claims.

I claim:

1. A pet water fountain comprising:
a basin configured to hold water;
a pump detachably mounted at the bottom of the basin;
a filter having a filter inlet and a filter outlet, the filter inlet being provided at the bottom of the filter and being detachably connected to a pump outlet of the pump, the filter outlet being provided at the top of the filter;
a cover placed in the basin and covering the pump and the filter, wherein a cover outlet is formed at the top of the cover, being connected to the filter outlet, and at least one circulating opening is configured at the bottom of the cover to connect inside and outside of the cover.

2. The pet water fountain of claim 1, wherein a recess is formed in the bottom of the basin, and the pump is attached in the recess by suction cups provided at the bottom of the pump.

3. The pet water fountain of claim 2, wherein a filter sponge is arranged in front of a pump inlet of the pump.

4. The pet water fountain of claim 1, wherein a wire guiding post is provided in an internal space of the basin that is covered by the cover, and the wire guiding post extends upwards from the bottom of the basin, having a wire guiding passage going from the top down to the outside of the bottom of the basin, and an electrical wire of the pump is led into the wire guiding passage from top to bottom and then is led out from the bottom of the basin.

5. The pet water fountain of claim 4, wherein the top of the wire guiding passage is stuffed by a silicone plug, and the silicone plug has an edge that is capable of being bent back to covering the wire guiding post.

6. The pet water fountain of claim 1, wherein a silicone tube is embedded into the cover outlet, and a lower end of the silicone tube is further embedded into the filter outlet.

7. The pet water fountain of claim 1, wherein the filter comprises an upper housing, a lower housing, and a filtering core housed in an internal space surrounded by the upper housing and the lower housing that are interlocked with each other.

8. The pet water fountain of claim 7, wherein the filtering core further comprises a frame, at least one non-woven filtering bags which is placed in the frame, an upper layer of non-woven cloth and a lower layer of non-woven cloth which are attached to corresponding upper end and lower end of the frame respectively.

9. The pet water fountain of claim 8, wherein each of the non-woven filtering bags is filled with activated carbon and/or ion-exchange resin.

10. The pet water fountain of claim 1, wherein a storage recess is formed at the top of the cover, with the cover outlet being at the bottom of the storage recess, and at least one spout is configured surrounding an upper edge of the storage recess at the top of the cover.
